(19) United States
(12) Patent Application Publication
(10) Pub. No.: US 2021/0113412 A1
(43) Pub. Date: Apr. 22, 2021

(54) Preloaded Personal Augmentation Suit and Method for Assisted Human Motion

(71) Applicant: SpringActive, Inc., Tempe, AZ (US)

(72) Inventors: Matthew A. Holgate, Mesa, AZ (US); Jeffrey A. Ward, Phoenix, AZ (US); Chase Wheeler, Mesa, AZ (US); Dustin Vehon, Mesa, AZ (US)

(73) Assignee: SpringActive, Inc., Tempe, AZ (US)

(21) Appl. No.: 16/655,221

(22) Filed: Oct. 16, 2019

(51) Int. Cl. A61H 1/02

(52) U.S. Cl. CPC A61H 1/0255; A61H 2201/1652; A61H 2205/102; A61H 2203/0418; A61H 2201/0173

(57) ABSTRACT

A human motion assistance device has an upper torso harness and a preloaded leg strap arrangement affixed to the upper torso harness. The preloaded leg strap arrangement has an X-bracket connected to the upper torso harness. The preloaded leg strap arrangement further uses a plurality of blocks and a preloaded strap routed through the blocks and connected to the X-bracket. The preloaded leg strap arrangement further uses a knee pad with a split seam. The preloaded strap is under tension, even when the human motion assistance device is in a relaxed state. The preloading provides an immediate force which increases under a loaded state. The potential energy stored during the loaded state is released when transitioning from a standing position to a crouched, squatting, or seated position. The configuration allows for maximizing the energy storage without putting excess shoulder pressure on the user when standing.

### FIELD OF THE INVENTION

The present invention relates in general to a human assistance device, and more particularly, to a preloaded personal augmentation suit and method for assisted human motion.

### BACKGROUND OF THE INVENTION

A variety of human assistance devices provide aid for human motion. Some work tasks and activities demand frequent and heavy lifting or long-term strenuous movement, beyond normal unassisted physical exertion, and can lead to exhaustion and potential injury. In particular, excessive strain on muscles and joints can cause injury to the back, legs, and knees with associated reduction in productivity, lost time from work, and higher health costs. The human assistance device, as worn by the user, is designed to overcome or compensate for the added load or strain and make many work tasks easier to perform with less risk of injury.

In one embodiment, the human assistance device uses an exoskeleton with rigid components e.g., linkages and joints, attached to the user's body. The exoskeleton joints are positioned to have an axis of rotation collinear with a natural axis of rotation for adjacent joints. The rigid exoskeleton relies on a framework of linkages connected to the body at select locations via pads and straps to provide the ability to augment human movements that need assistance or otherwise enhance the user's performance, stability, balance, and safety. As the user flexes or extends his limbs, these rigid links move in parallel with the limb, adding considerable inertia to movement. Unfortunately, the rigid exoskeleton also causes considerable restriction to the user's range of motion and impedes natural and fluid movement.

In another example, U.S. patent publication 2015/0321339 discloses a soft exosuit that generates forces about one or more joints based on anchor elements and connection elements disposed between the anchor elements. The exosuit uses sensors to determine forces on the anchor or connection elements. Actuators are configured to change tension in the soft exosuit in response to the sensors. The exosuit tends to be complex with an overreliance on active components, such as sensors and actuators, to control its operation. The intricate interconnection of anchor elements, connection elements, sensors, and actuators tends to be expensive to manufacture, difficult to configure, slow in response, and overall low reliability.

### BRIEF DESCRIPTION OF THE DRAWINGS

FIGS. 1a-1c illustrate front, back, and side views of a passive P2K suit with a backpack assembly, preloaded leg strap arrangement, split knee pad, and ankle cuffs;

FIG. 2 shows the split knee pad open for ease of donning and doffing;

FIG. 3 illustrates a portion of preloaded leg strap arrangement with an X-bracket and preloaded strapping;

FIG. 4 illustrates further detail of the preloaded strap with blocks and elastic strapping under tension;

FIG. 5 illustrates the preloaded straps connected between the X-bracket and split knee pads;

FIG. 6 illustrates another embodiment of the preloaded straps connected between the X-bracket and split knee pads;

FIGS. 7a-7c illustrate various positions of the user wearing the passive P2K suit to lift a load;

FIGS. 8a-8b illustrate the preloaded straps under a relaxed state and loaded state;

FIG. 9 is a chart of force and motion for the preloaded leg strap arrangement; and

FIG. 10 illustrates an alternate embodiment of the blocks and elastic strapping under tension.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, those skilled in the art will appreciate that the description is intended to cover alternatives, modifications, and equivalents as may be included within the spirit and scope of the invention as defined by the appended claims and their equivalents as supported by the following disclosure and drawings.

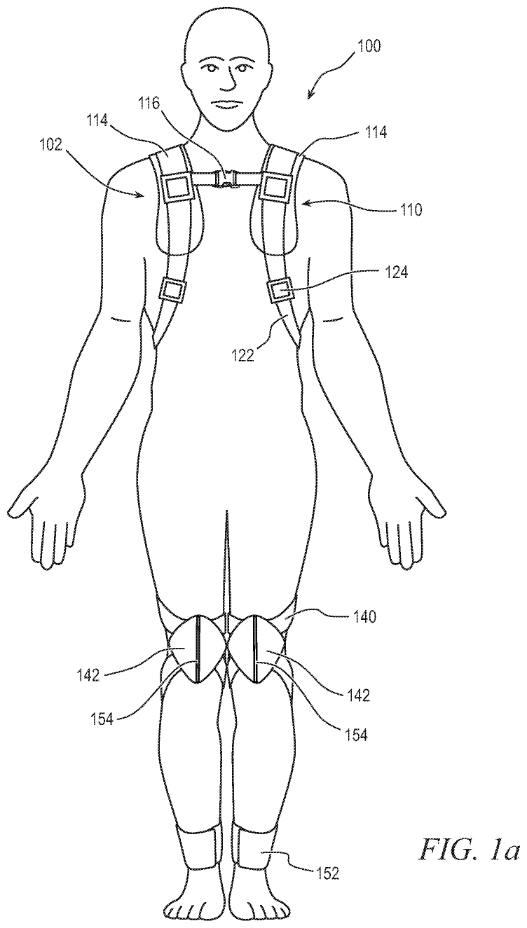

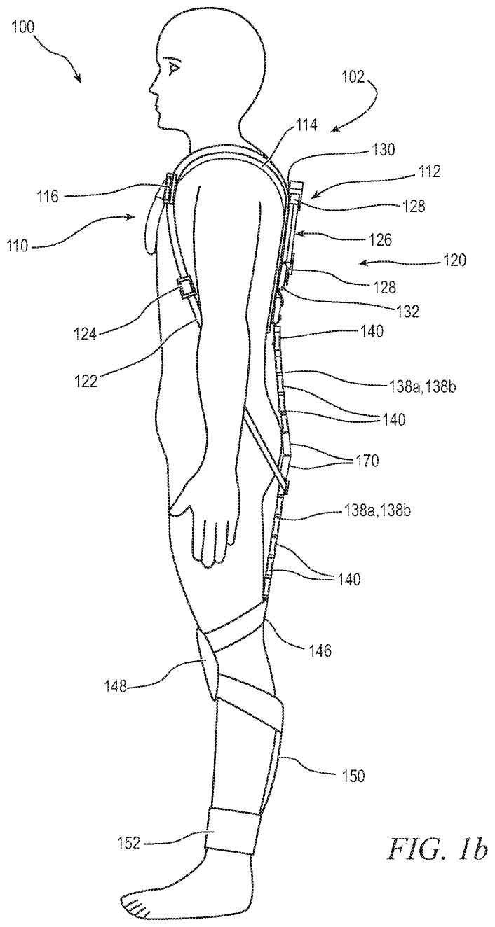

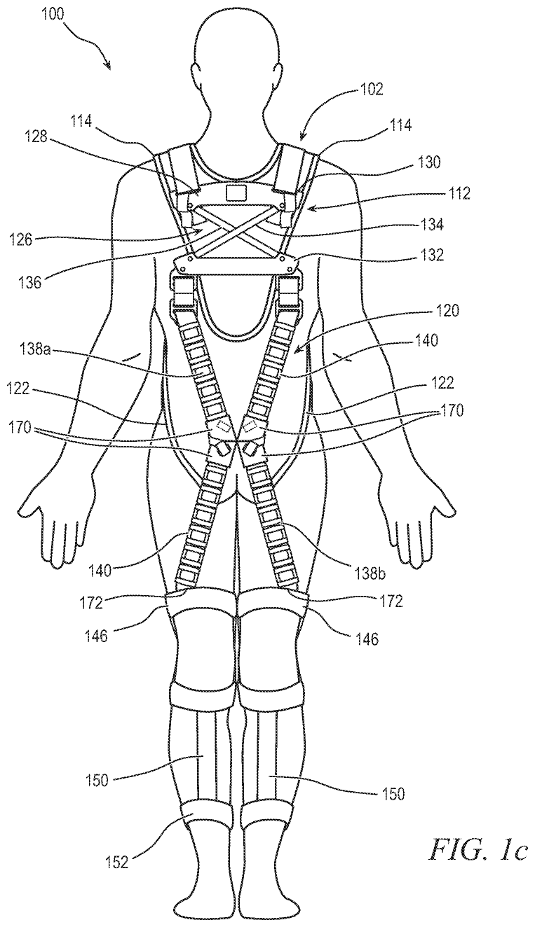

FIGS. 1a-1c show front, side, and back views, respectively, of user 100 wearing potential-to-kinetic suit (P2K) 102 suitable for human assistance in crouching, squatting, sitting, standing, and lifting under load. P2K 102 is a passive personal augmentation suit or strapping system, i.e., no active components, applicable to many types of human activity and physical work, such as moving heavy articles, up and down motion under load, and other repetitive, long-term physical exertion. P2K 102 is capable of storing potential energy in the strapping arrangement, e.g., potential energy is stored in elastic strapping when transitioning from a standing position to a crouched or squatting position. The potential energy in P2K 102 is released when user 100 moves from the crouched or squatting position to return upright in stance, thereby assisting the user in the motion, particularly while under load. P2K 102 is preloaded, as described infra, to immediately assist with mobility. P2K 102 increases endurance, reduces fatigue, and decreases potential for injury associated with such activity, particularly for the user's back, legs, and knees. P2K 102 includes an interconnected arrangement of preloaded elastic straps, blocks, anchors, and buckles to provide passively loaded support and reaction for user 100 while assisting with human motion under load. Portions of P2K 102 can be reflective material for safety.

FIG. 1a is a front view of P2K 102 showing upper torso harness 110 with shoulder straps 114; FIG. 1b is a side view of P2K 102 including backpack assembly 112; FIG. 1c is a back view of P2K 102. Backpack assembly 112 can include a combination of durable materials such as textured nylon, polyurethane coated polyester, and rigid plastic or polymer inserts, as well as elastic material and webbing material. Backpack assembly 112 can be made with an air mesh material with openings to allow for air-flow on the back and reduce the overall weight. Backpack assembly 112 covers a portion of back area of user 100 to improve ergonomics and comfort, relieve lower back pressure, and ease of donning and doffing. Shoulder straps 114 extend over the shoulder and affix to backpack assembly 112 with sewing, rivets, belt, buckles, buttons, snaps, hooks, adhesive, VELCRO®, or other secure attachment mechanism, as shown in FIG. 1b. Shoulder straps 114 are made with elastic material or webbing material and can slide, loosen, or tighten relative to backpack assembly 112 for user comfort and adapting to movement. Buckle 116 in shoulder straps 114 provides adjustment and attachment points. Buckle 116 snaps to lock and enable P2K 102 to fit different body sizes.

In FIG. 1c, backside preloaded strap arrangement 120 includes X-bracket 126 with an upper bar 128 connected to backpack assembly 112 at connection location 130 with sewing, rivets, belt, buckles, buttons, snaps, hooks, adhesive, VELCRO®, or other secure attachment mechanism. Upper bar 128 connects to lower bar 132 with crossing members 134 and 136 to allow lower bar 132 to move or rock based on relative motion of preloaded straps 138a and 138b. Backside preloaded strap arrangement 120 slides or moves relative to backpack assembly 112 to enable or minimize medial/lateral relative motion. Shoulder straps 114 anchor to backpack assembly 112, and side straps 122 extend from backpack assembly 112 under the arms and along the side torso of user 100 to backpack assembly 112 or backside preloaded strap arrangement 120. Side straps 122 can include elastic material with buckles 124 for adjustments and comfort.

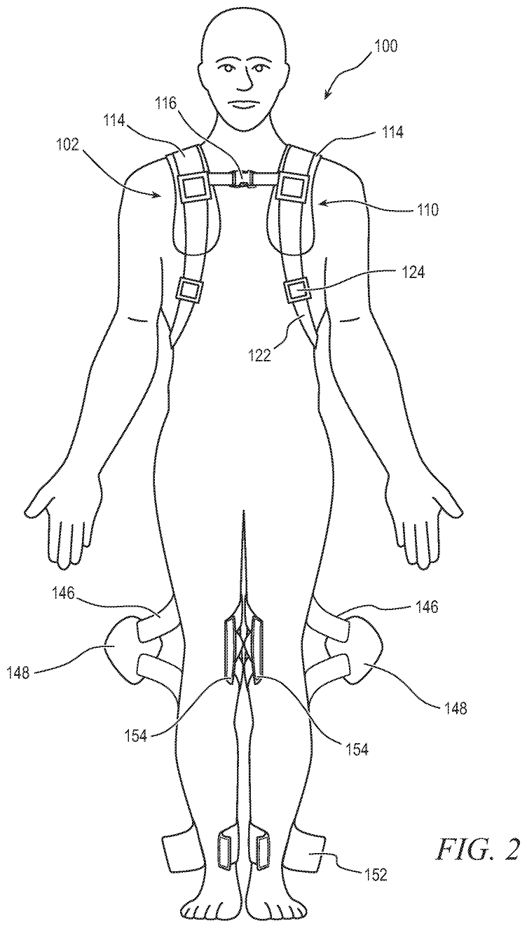

Preloaded straps 138a and 138b with blocks 140 are substantially aligned along the back of user 100 and extend down the legs of user 100 to thigh straps 146, which connect to a portion of knee pads 148. Calf straps 150 connect between a portion of knee pads 148 and ankle cuffs 152. Knee pads 148 provide padding and protection of the knee while kneeling on the ground. Knee pads 148 open or split along vertical or angled seam 154 and close with buttons, snaps, hooks, VELCRO®, or other secure attachment mechanism for ease of donning and doffing P2K 102, as shown in FIG. 2. Likewise, ankle cuffs 152 open or split and close with buttons, snaps, hooks, VELCRO®, or other secure attachment mechanism for ease of donning and doffing P2K 102. In one embodiment, knee pads 148 open and close with a magnetic strip connection along seam 154. When the magnetic strips are brought into close proximity, knee pads 148 readily close with the magnetic attraction. A similar magnetic connection can be made for ankle cuffs 152 and backpack assembly 112.

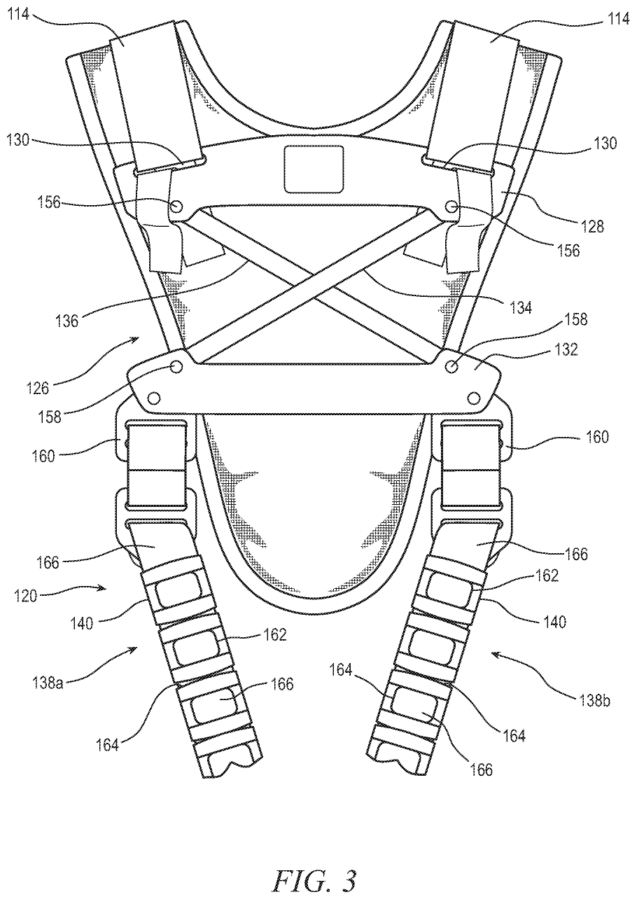

FIG. 3 shows further detail of X-bracket 126 attached to backside preloaded strap arrangement 120 with an upper bar 128 connected to shoulder straps 114 at connection location 130 with sewing, rivets, belt, buckles, buttons, snaps, hooks, adhesive, VELCRO®, or other secure attachment mechanism. Upper bar 128 provides a horizontal anchor between shoulder straps 114. Crossing members 134 and 136 connect to upper bar 128 with revolute joint or rivets 156 to allow the cross members to rotate with respect to upper bar 128. Crossing members 134 and 136 also connect to lower bar 132 with revolute joint or rivets 158 to allow the cross members to rotate with respect to lower bar 132. Accordingly, lower bar 132 is free to move or rock in a differential manner with respect to upper bar 128 depending on the relative motion of preloaded straps 138a and 138b. That is, strap 138a moves up while strap 138b moves down, and visa versa.

Preloaded straps 138a and 138b connect to lower bar 132 of X-bracket 126 with upper anchor buckles 160 using sewing, rivets, belt, buckles, buttons, snaps, hooks, adhesive, VELCRO®, or other secure attachment mechanism. Preloaded straps 138a and 138b use a plurality of individual blocks 140 with openings 162 and rounded or curved contacting ends 164. Elastic or stretchable strapping 166 connects to upper anchor buckles 160 and extends through blocks 140. Blocks 140 maintain the preload on strapping 166.

FIG. 4 illustrates further detail of elastic strapping 166 extending through openings 168 of block 140. Elastic strapping 166 does not connect or anchor to any particular block 140, but rather block 140 freely slides over elastic strapping 166 within openings 168. Elastic strapping 166 is visible through opening 162. Straps 138a and 138b are preloaded with tension, even when P2K 102 is in a relaxed state, i.e., user 100 upright. The preloading involves stretching elastic straps 166 prior to attachment to upper anchor buckle 160, mid-anchor buckles 170, and thigh strap 146. The spacing of blocks 140, when touching end 164 of one block 140 to end 164 of an adjacent block 140, sets a minimum length of preloaded straps 138a and 138b. The preload arises from elastic strapping 166 being stretched beyond the minimum length of straps 138a and 138b due to blocks 140. Accordingly, blocks 140 maintain the preload of elastic strapping 166 and keep preloaded straps 138a and 138b under constant tension, again even with P2K 102 in a related state.

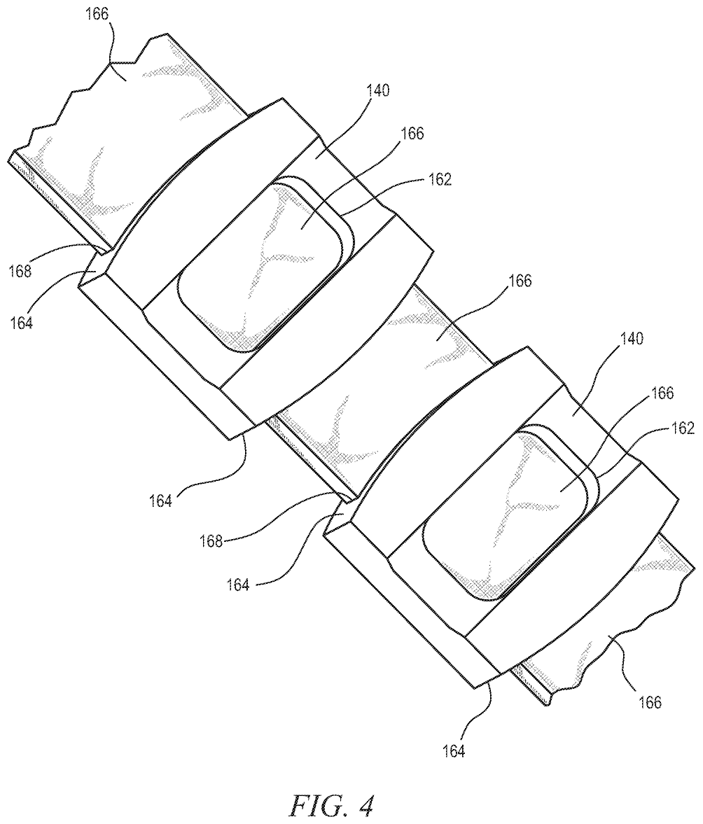

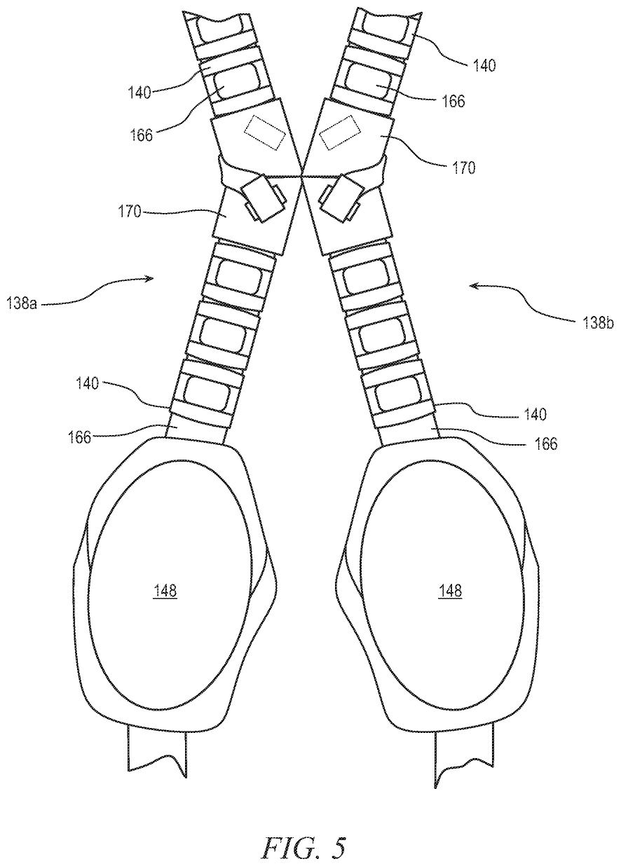

FIG. 5 illustrates preloaded straps 138a and 138b connected to upper anchor buckle 160 continuing from FIG. 3 and further connected to mid-anchor buckles 170 using sewing, rivets, belt, buckles, buttons, snaps, hooks, adhesive, VELCRO®, or other secure attachment mechanism. Mid-anchor buckles 170 have a 30-45 degree angle and are positioned proximate to the lower back of user 100. Preloaded straps 138a and 138b continue from mid-anchor buckle 170 to connection point 172 on thigh straps 146 and are secured using sewing, rivets, belt, buckles, buttons, snaps, hooks, adhesive, VELCRO®, or other secure attachment mechanism.

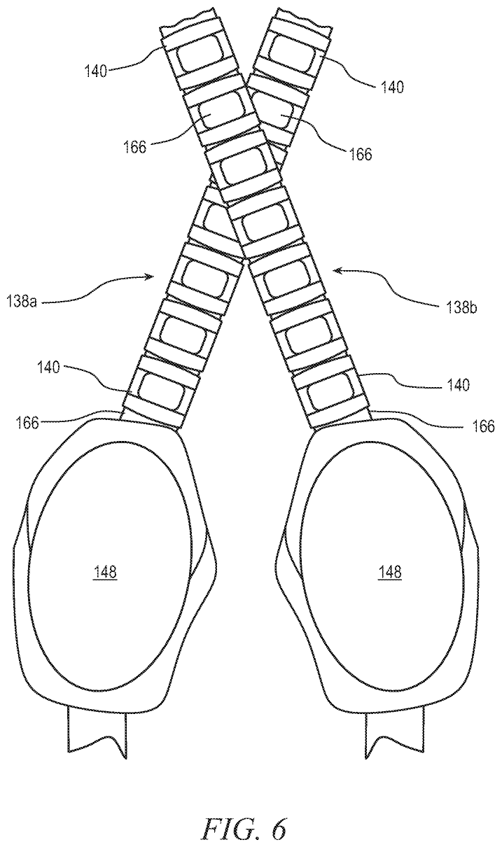

FIG. 6 illustrates another embodiment of preloaded straps 138a and 138b connected to upper anchor buckle 160 continuing from FIG. 3 and further connected to thigh straps 146 using sewing, rivets, belt, buckles, buttons, snaps, hooks, adhesive, VELCRO®, or other secure attachment mechanism. Preloaded straps 138a and 138b continue straight through to the opposite limb, i.e. left shoulder strap 114 connects to right thigh strap 146 and right shoulder strap 114 connects to left thigh strap 146.

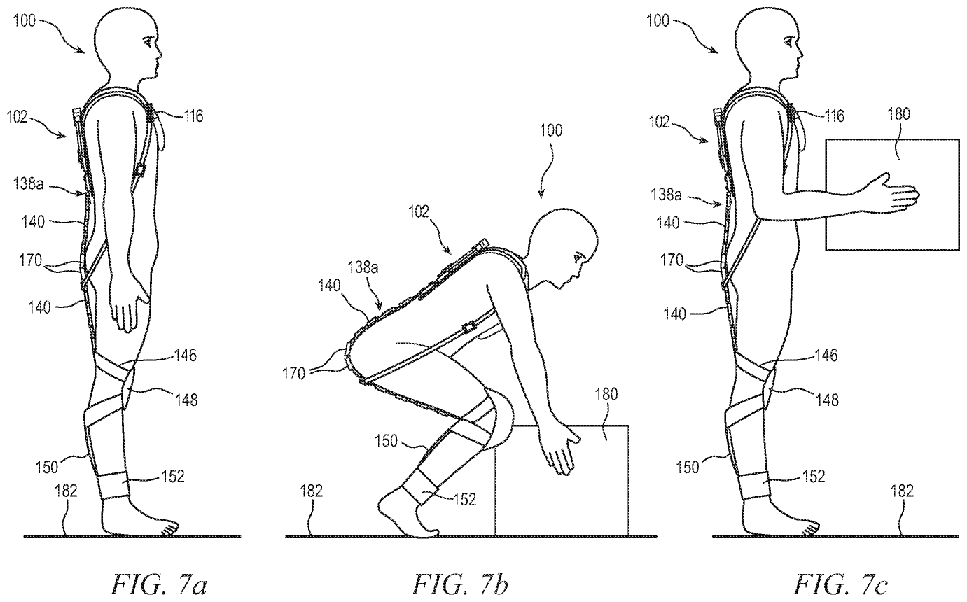

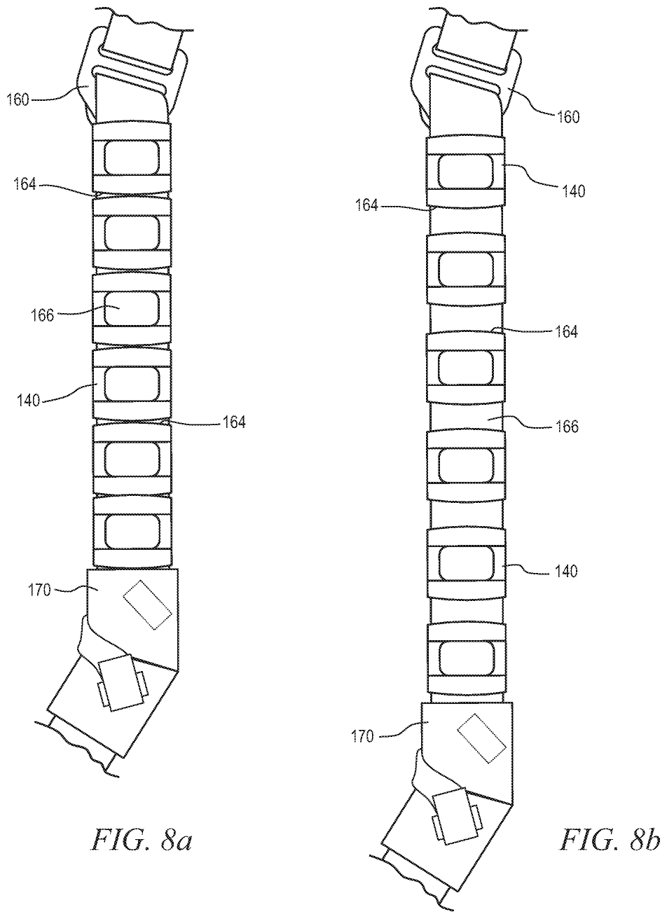

FIG. 7a shows user 100 in a standing position with no load. P2K 102 is in a relaxed state but with straps 138a and 138b preloaded by stretching elastic straps 166. FIG. 8a corresponds to a relaxed but with a preloaded state of straps 138a and 138b. There is no load on the shoulders of user 100 even with straps 138a and 138b preloaded. Blocks 140 are held together and contact on rounded or curved ends 164 due to the preloading on elastic strapping 166, as shown in FIG. 8a. Curved ends 164 provide free and natural movement of the straps 138a and 138b in its preloaded state.

FIG. 7b shows user 100 in a squatting position to grip and lift load 180 from ground 182. Upon lifting load 180, P2K 102 is in a loaded state in excess of the preloading on straps 138a and 138b. FIG. 8b corresponds to a loaded state of straps 138a and 138b, i.e., with user 100 squatting to pick up load 180 from ground 182. Blocks 140 are intended to float along strapping 166 and separate from one another under extended stretching of strapping 166 from the position of user 100, as shown in FIG. 8b. The counter force to load 180 and weight of user 100 is applied immediately due to preloaded straps 138a and 138b. Load line 190 in FIG. 9 shows a positive preloading force F on straps 138a and 138b even with zero ΔX of P2K 102, i.e., FIG. 7a. The squatting motion of user 100 in FIG. 7b further stretches preloaded straps 138a and 138b to increase ΔX and force F. Accordingly, force F starts at a positive value with preloading (ΔX=0) and continues to increase with the loaded state of FIG. 7b with a positive ΔX. While the user 100 only feels this force when stretching the preloaded straps 138a and 138b such that blocks 140 are no longer contacting each other.

FIG. 7c shows user 100 returning to a relaxed state as in FIG. 7a, with load 180, straps 138a and 138b return to the preloaded state of FIG. 8a. Blocks 140 again contact on curved ends 164 and straps 166 and remain stretched and under tension due to the preload.

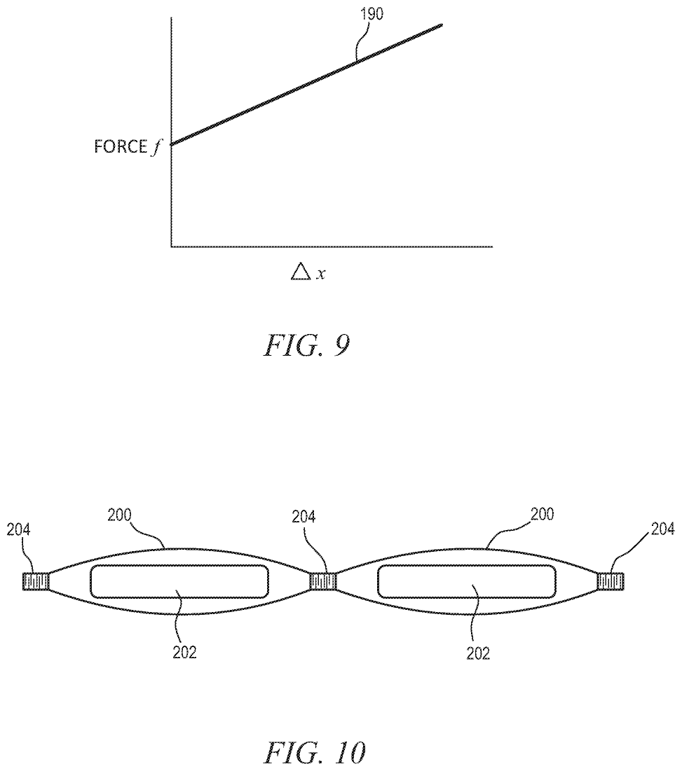

FIG. 10 illustrates an alternate preloaded strap arrangement with strapping 200 under tension even in a relaxed state of P2K 102. Blocks 202 are placed between strapping 200. The portion of strapping 200 between blocks 202 is sewn together at connection points 204 to hold blocks 202 in place. Blocks 202 maintain the preload on strapping 200.

P2K 102 stores potential energy in the preloaded strapping arrangement, e.g., the elastic strapping stretches and stores potential energy when transitioning from a standing position to a crouched, squatting, or seated position. The potential energy in P2K 102 remains available while user 100 is seated or squatting to assist with the opposing motion, i.e., standing up with or without load. When user 100 stands up from the seated position with load 180, similar to FIGS. 7b-7c, the potential energy in P2K 102 is released to assist the user in the motion. A similar concept applies to user 100 standing from the seated position. P2K 102 reduces the effort, strain, fatigue, and potential for injury associated with such movement in physical labor work environments. P2K 102 is adjustable for size and pre-tensioning the elastic components.

In general, P2K 102 utilizes a flexible, modular, passive strapping system that, in one embodiment, extends from upper torso harness 110 along preloaded straps 138a and 138b to thigh straps 146 and knee pads 148. P2K 102 further extends from knee pads 148 over the calf area with calf straps 150 to ankle cuffs 152. P2K 102 gains support from upper torso harness 110 and preloaded straps 138a and 138b, as well as the strapping arrangement around the back of the thigh, front of the knee, and back of the tibia to anchor at the ankle. Because the preloaded straps over the length of the leg, the strapping arrangement stores energy in the elastic bands or springs during the squatting or crouching motion to be released during transition to the standing position thus assisting with human motion under load. The preloaded straps 138a and 138b also hold P2K 102 in place during various movements, such as squatting.

While one or more embodiments of the present invention have been illustrated in detail, the skilled artisan will appreciate that modifications and adaptations to those embodiments may be made without departing from the scope of the present invention as set forth in the following claims.

What is claimed:

1. A human motion assistance device, comprising:
an upper torso harness configured to attach to a user; and
a leg strap arrangement affixed to the upper torso harness, wherein the leg strap arrangement is preloaded under tension.

2. The human motion assistance device of claim 1, wherein the leg strap arrangement includes:
a plurality of blocks; and
a preloaded strap routed through or around the blocks.

3. The human motion assistance device of claim 2, wherein the blocks include a curved end.

4. The human motion assistance device of claim 1, wherein the leg strap arrangement includes a knee pad.

5. The human motion assistance device of claim 4, wherein the knee pad includes a split seam.

6. The human motion assistance device of claim 5, wherein the split seam includes a magnetic connection or buckle.

7. A human motion assistance device, comprising:
an upper torso harness; and
a preloaded leg strap arrangement affixed to the upper torso harness.

8. The human motion assistance device of claim 7, wherein the preloaded leg strap arrangement includes an X-bracket connected to the upper torso harness.

9. The human motion assistance device of claim 8, wherein the preloaded leg strap arrangement includes:
a plurality of blocks; and
a preloaded strap routed through or around the blocks and connected to the X-bracket.

10. The human motion assistance device of claim 9, wherein the blocks include a curved end.

11. The human motion assistance device of claim 7, wherein the preloaded leg strap arrangement includes a knee pad.

12. The human motion assistance device of claim 11, wherein the knee pad includes a split seam.

13. The human motion assistance device of claim 12, wherein the split seam includes a magnetic connection or buckle.

14. A method of making a human motion assistance device, comprising:
providing an upper torso harness; and
affixing a preloaded leg strap arrangement to the upper torso harness.

15. The method of claim 14, wherein providing the preloaded leg strap arrangement includes providing an X-bracket connected to the upper torso harness.

16. The method of claim 15, wherein the preloaded leg strap arrangement includes:
providing a plurality of blocks; and
routing a preloaded strap through or around the blocks and connecting to the X-bracket.

17. The method of claim 16, wherein the blocks include a curved end.

18. The method of claim 14, wherein providing the preloaded leg strap arrangement includes providing a knee pad.

19. The method of claim 18, wherein the knee pad includes a split seam.

20. The method of claim 19, wherein the split seam includes a magnetic connection or buckle.
